(19) United States
(12) Patent Application Publication
(10) Pub. No.: US 2026/0187866 A1
(43) Pub. Date: Jul. 2, 2026

(54) DIFFUSION IN STYLE

(71) Applicant: LARGO FILMS SA, Lausanne (CH)

(72) Inventors: Martin Nicolas EVERAERT, Chavannes-près-Renens (CH); Radhakrishna ACHANTA, Vallorbe (CH); Marco BOCCHIO, Le Mont-sur-Lausanne (CH); Sami ARPA, Cully (CH); Sabine SÜSSTRUNK, Lausanne (CH)

(21) Appl. No.: 19/130,082

(22) PCT Filed: Jun. 6, 2023
(86) PCT No.: PCT/EP2023/065063

§ 371 Date: May 14, 2025

(51) Int. Cl. G06T 11/10; G06F 40/40

(52) U.S. Cl. CPC G06T 11/10; G06F 40/40

(57) ABSTRACT

A method is provided for adapting a diffusion-based image generation model (2) comprising at least a denoising autoencoder (4). The method comprises: obtaining a style-specific noise distribution in an image space or in a latent space for a respective set of target style images; and adjusting parameters of the denoising autoencoder (4) by using the style-specific noise distribution to adjust the parameters of the denoising autoencoder (4) to obtain an adapted diffusion-based image generation model (2).

### TECHNICAL FIELD

The present invention relates to a new method for adapting a diffusion-based image generation model. The new method is a simple method for few-shot adaptation of a diffusion-based image generation model, such as “Stable Diffusion”, to allow the adapted model to generate images of any desired style. The present invention also relates to an apparatus and a computer program product configured to implement the proposed method.

### BACKGROUND OF THE INVENTION

Generating images of a specific style using large-scale text-to-image models, such as Stable Diffusion, is an attractive idea as they can generate high-quality output images from textual prompts. However, enforcing a coherent style on the generated images is not a straightforward task. The style often cannot be expressed well enough with a textual prompt. Consequently, the model needs to be fine-tuned. However, current approaches for fine-tuning Stable Diffusion or similar text-to-image models to a particular style suffer from one or more of the following limitations: results can be far from aesthetically pleasing, results may not match the desired style precisely, the method may require impractical amount of data and computational resources, or fine-tuned models may undergo catastrophic forgetting.

To generate images, Stable Diffusion uses a conditional U-Net to progressively denoise a tensor in the latent space of a variational autoencoder (VAE). This latent tensor is initially sampled from a standard multivariate Gaussian distribution. The U-Net is conditioned on a textual prompt to iteratively denoise the noisy latent tensor. The textual prompt is pre-processed by a contrastive language-image pre-training (CLIP) text encoder, before being used as conditioning for the U-Net. Finally, the denoised latent tensor is passed through a VAE decoder to obtain the generated image.

We observe empirically that the initial latent tensors influence the style and layout of generated images: images generated with the same initial latent tensor and different textual prompts often lead to images with shared attributes. We therefore hypothesise that the difficulties to generate images of a desired style arise from the fact that the style-agnostic noise distribution used in the forward diffusion process of Stable Diffusion (or of other similar models) is not adapted for generating style-specific images.

In the case of Stable Diffusion, the most common ways of controlling the style of generated images are based on prompt engineering, or on fine-tuning with a large number of target style images as briefly explained next.

In prompt engineering, a natural way to influence the style of images generated with Stable Diffusion is to describe the style in a textual prompt. Typically, one appends modifier words or sentences in the prompts, such as names of artists, e.g., “Greg Rutkowski”; art forms, e.g., “#pixelart”; visual art types, e.g., “in the style of a cartoon”; camera parameters, e.g., “Polaroid” or “80 mm Sigma f/1.4”, etc. This method fails when we are aiming for a specific style that cannot be described precisely with a limited number of words.

Stable Diffusion can also be used to edit existing images, rather than creating completely new ones. This approach can be used to stylise an image, but the same limitation as in other prompt engineering solutions remains, namely it is impossible to get a desired style that cannot be described in words.

Textual inversion introduces a new way of doing prompt engineering, by way of learning new vocabulary from a small set of guidance images. To generate images of a specific concept or of a specific style, textual inversion optimises the embedding of new tokens in a frozen diffusion model. However, similar to the other prompt engineering techniques, this approach is restricted by the ability of text embedding to capture details of the style, and it is also confined to the model's initial output domain, and hence, the obtained images may not match the target style correctly.

To overcome the inability of the frozen model to generate images of a specific style, fine-tuning the U-Net of Stable Diffusion on a set of images is feasible, but requires lots of computational resources or a high number of images. Different methods typically require tens of thousands of target images and are fine-tuned for up to a quarter million iterations.

More advanced fine-tuning methods can be used to reduce computational resources or data requirements. However, fine-tuning of Stable Diffusion based on these methods often matches the style less effectively than more traditional fine-tuning methods. In other words, these more advanced fine-tuning methods do not typically perform sufficiently well for style adaptation.

It has been shown that diffusion models can be generalised to image deteriorations other than noise in the forward diffusion process. These include, for instance, blurring, masking, or pixelations. These types of image corruption can result in faster image generation and better image quality than regular image diffusion models with Gaussian noise. These approaches re-train diffusion models to perform other reverse diffusion tasks, e.g., deblurring or super-resolution instead of denoising. However, these approaches change the type of image degradation. In other words, these approaches change the type of forward diffusion, e.g., pixelation or blur, and then re-train from scratch. However, this kind of operation is often not ideal.

### SUMMARY OF THE INVENTION

It is an object of the present invention to overcome at least some of the problems identified above by proposing a new computer-implemented method, hereinafter also referred to as “Diffusion in Style”, for adapting diffusion-based image generation models, such as conditional diffusion-based image generation models, to enable them to generate images or videos that better correspond to the desired image style. Another object of the present invention is to propose a new diffusion-based image or video generation computer-implemented method to generate images and/or videos that better correspond to the desired style than images or videos obtained with the existing diffusion-based image generation methods. In other words, one of the objects of the present invention is to propose a new diffusion model adaptation method.

According to a first aspect of the present invention, there is provided a method for adapting a diffusion-based image generation model as recited in claim 1.

According to a second aspect of the present invention, there is provided a method of generating an image of a desired style by using a diffusion-based image generation model adapted according to the method of the first aspect as recited in claim 15.

According to a third aspect of the present invention, there is provided a non-transitory computer program product comprising instructions for implementing the steps of the method according to the first and/or second aspects of the present invention when loaded and run on computing means of a computing device.

According to a fourth aspect of the present invention, there is provided a diffusion-based image generation system configured to carry out the method according to the first and/or second aspect of the present invention.

Other aspects of the invention are recited in the dependent claims attached hereto.

The present invention is based on the key observation that the style of the images generated by Stable Diffusion or by any similar model is tied to the initial latent tensor. Adapting this initial latent tensor to a given style is much easier, as opposed to prompt engineering, or fine-tuning Stable Diffusion or any other similar model using a very large dataset of images of the same style. The former might not be able to correctly define the desired style, while the latter is slow, expensive, and often impractical, especially when only a few target style images are available. In contrast, the proposed Diffusion in Style is orders of magnitude more sample-efficient and faster. The proposed method also generates more pleasing images than existing approaches.

The present invention thus proposes Diffusion in Style, which is a new method for adapting diffusion-based image generation models, including text-to-image diffusion-based models such as Stable Diffusion, so that the performance of the adapted model is improved compared with existing image generation models. The key idea behind the proposed method is to start the denoising process with style-relevant initial noise samples. If the diffusion occurs in a latent space, these style-relevant initial noise samples are latent tensors (i.e., noise samples in the latent space). If the diffusion occurs in the pixel space, these style-relevant initial noise samples are images composed of noise. According to the present invention, this is done by computing an element-wise mean and standard deviation of the latent encodings of the target style images (if the images are processed in the latent space), or pixel-wise mean and standard deviation of the target style images (if the diffusion process relies on the pixel space). What remains is a simple fine-tuning step of the denoising autoencoder (the U-Net in case of Stable Diffusion) that requires orders of magnitude fewer images and/or training iterations than the previous approaches. In other words, the proposed method uses the element-wise mean and variance of the latent tensors as a prior of the style. Subsequently, Stable Diffusion or any other similar model is fine-tuned on target style images, which can be implemented more efficiently with our style prior.

A diffusion model adapted by using Diffusion in Style can generate visually pleasing results. The highlights of Diffusion in Style are:
(1) To our knowledge, it is the first method that modifies the initial latent distribution for style adaptation, instead of modifying the textual prompt or fine-tuning the denoising autoencoder with a large amount of data.
(2) Diffusion in Style requires only a few images from the target style, typically 50 to 200. This opens the door to many practical applications where thousands of images of the desired style might not be available. Through minor modifications presented later in this description, the proposed method can also work with as few as three target style images.
(3) Diffusion in Style is computationally efficient. The step of fine-tuning the denoising autoencoder, such as the U-Net, on the style-specific distribution computed earlier, requires only 1000 iterations. This takes less than 20 minutes on a Tesla V100 graphics processing unit (GPU).

Compared to existing fine-tuning approaches, the fine-tuning operation according to the present invention is orders of magnitude more sample-efficient and faster, thanks to adapting the initial latent distribution to the style. By requiring relatively few target images, typically 50 to 200, individual artistic styles can be leveraged. Furthermore, compared to existing models modifying the forward diffusion process, a key difference between these approaches and the present invention is that we do not change the type of image degradation. The approach according to the present invention only changes the location and covariance of the Gaussian distribution from which the initial latent tensors are sampled and then denoised. In other words, instead of changing the type of forward diffusion, e.g. pixelation or blur, and re-training from scratch, we only replace the style-agnostic distribution of the Gaussian noise with a style-specific distribution and fine-tune the artificial neural network during a small number of iterations.

### BRIEF DESCRIPTION OF THE DRAWINGS

Other features and advantages of the invention will become apparent from the following description of non-limiting example embodiments, with reference to the appended drawings, in which:

FIG. 1 is a simplified block diagram schematically illustrating an imaging system where the teachings of the present invention can be implemented;

FIG. 2 shows input data elements and an output data element of a sampling algorithm shown in FIG. 1;

FIG. 3 shows some example style adaptations induced by a text-to-image diffusion-based image generation model that has been adapted by using Diffusion in Style;

FIG. 4 illustrates conventional versus style-adapted forward diffusion process;

FIG. 5a shows an example flow chart illustrating the steps of adapting a diffusion model to different styles, according to an example embodiment of the present invention;

FIG. 5b shows an example flow chart illustrating the steps of fine-tuning the denoising autoencoder of the diffusion model to a particular style, according to an example embodiment of the present invention;

FIG. 6 shows an example flow chart illustrating the steps of an image generation method according to an example embodiment of the present invention;

FIG. 7 schematically illustrates two main stages of a method for adapting a diffusion model according to an example embodiment of the present invention;

FIG. 8 schematically illustrates the step of running a sampling algorithm to generate one or more images of the desired style; and.

FIG. 9 shows a visual representation of the location of the adapted noise distribution for some example styles, a visual representation of four random samples from the noise distribution for the example styles, as well as four images generated unconditionally with the adapted diffusion model for the example styles.

### DETAILED DESCRIPTION OF EMBODIMENTS OF THE INVENTION

Some embodiments of the present invention will now be described in detail with reference to the attached figures. As utilised herein, “and/or” means any one or more of the items in the list joined by “and/or”. As an example, “x and/or y” means any element of the three-element set {(x), (y), (x, y)}. In other words, “x and/or y” means “one or both of x and y.” As another example, “x, y, and/or z” means any element of the seven-element set {(x), (y), (z), (x, y), (x, z), (y, z), (x, y, z)}. In other words, “x, y and/or z” means “one or more of x, y, and z.” Furthermore, the term “comprise” is used herein as an open-ended term. This means that the object encompasses all the elements listed, but may also include additional, unnamed elements. Thus, the word “comprise” is interpreted by the broader meaning “include”, “contain” or “comprehend”. Identical or corresponding functional and structural elements which appear in the different drawings are assigned the same reference numerals. Furthermore, the word “between” is used in the present description inclusively to also include the end points of a given range in a selection.

Some notations used in the present description are next briefly explained.

In machine learning, training or fine-tuning refers to the task of learning or updating some or all the parameters of a machine learning model. These parameters comprise for instance the weights of the layers of the model. Training or fine-tuning is typically performed with some variant of the stochastic gradient descent optimisation method. Such optimisation method is referred to as an optimiser. A loss function is designed to assess the degree of error made by the model. The optimiser is used iteratively, batch after batch of data, to update the parameters of the model based on the gradient of the loss and the optimiser's update rule. A simple example of an optimiser update rule consists in subtracting from the model's parameters the product of the gradient of the loss and a constant called learning rate.

A latent space, sometimes referred to as a latent feature space or embedding space, is an embedding of a set of items in a space in which items resembling each other are typically positioned closer to one another than in a feature space, such as an image space (i.e., pixel space). Position within the latent space can be defined by a set of latent variables that emerge from the resemblances from the objects. Typically, the dimensionality of the latent space is chosen to be lower than the dimensionality of the feature space, in this case image space, from which the data points are drawn, making the construction of a latent space an example of dimensionality reduction, which can be understood as a form of data compression. As an example, Stable Diffusion uses a variational autoencoder (VAE) to transform images (data points in a pixel space) into latent encodings (data points a latent space), and vice versa. In the case of Stable Diffusion (version 1), the dimensionality of the pixel space is 512×512×3, while the dimensionality of the corresponding latent space is 64×64× 4.

A text-to-image model is a machine learning model, which takes as input a textual prompt and then consequently produces an image matching that prompt. Text-to-image models typically combine a language model, which transforms the input text into a latent representation, and a generative image model, which produces an image conditioned on that representation. The most effective models have generally been trained on large amounts of image and text data.

A conditional image generation model is an extension of a text-to-image model, in which the conditioning parameter is a given instruction or a set of instructions not limited to textual prompts. These instructions may for instance comprise a voice input, an image, a gesture, a text element, or another modality.

Prompt engineering is a concept in artificial intelligence (AI), in particular in natural language processing (NLP). According to prompt engineering, the description of a task is embedded in the text input (i.e., textual prompt) of a frozen language model or a frozen text-to-image model, e.g., as a question or as modifier words, as opposed to training or fine-tuning the model explicitly for the task. Prompt engineering refers to the action of designing textual prompts that modifies the behaviour of the model in a way that better matches the desired task. As an example, one way to modify the behaviour of a text-to-image model into generating more realistic images is to add modifier words as “hyperrealistic” into the text input.

In machine learning, diffusion models, sometimes also referred to as denoising diffusion probabilistic models, are a class of Markov chains trained using variational inference. Diffusion models may be designed to learn the structure of a dataset by modelling the way in which data points diffuse through a space. Diffusion models can be applied to different tasks, including image denoising, inpainting, super-resolution, image generation, and video generation. In the case of image generation, the forward diffusion process consists of noising images (or their latent encodings) with Gaussian noise, and an artificial neural network, namely, a denoising autoencoder, is trained to reverse this diffusion process, i.e., denoise images contaminated with Gaussian noise. At inference time, an image generation model would start with random noisy images and then, by iteratively denoising them, the denoising autoencoder would be able to generate new natural images. The diffusion model or denoising diffusion probabilistic model as used in the present invention may operate in a latent space (latent diffusion model) or directly in an image space (i.e., pixel space).

The dimension of a mathematical space or object is defined as the minimum number of coordinates needed to specify any point within it.

Image denoising is the process of removing noise from an image. The goal of image denoising is thus to estimate the original image by suppressing noise from a noise-contaminated version of the image. Image denoising can for instance be used to decrease grainy spots and discoloration in images while minimising the loss of image quality. Equivalently to estimating the original image, the process of image denoising can also be framed as estimating the noise that needs to be removed from the noise-contaminated version of the image.

U-Net is a convolutional artificial neural network architecture that was originally developed for biomedical image segmentation. The U-Net architecture is based on the one of fully convolutional neural networks. The network consists of a contracting path and an expansive path, which gives the network the u-shaped architecture. The contracting path is a typical convolutional network consisting of repeated application of convolutions, each followed by a rectified linear unit (ReLU) and a max pooling operation. During the contraction operation, feature information is increased while spatial information is reduced. The expansive path combines the feature and spatial information through a sequence of up-convolutions and concatenations with high-resolution features from the contracting path. Although originally designed for segmentation, the U-Net architecture is used for many other computer vision tasks, including visual saliency detection and image denoising.

Stable Diffusion (or any other similar text-to-image diffusion-based image generation model) is a deep learning, text-to-image model. It is mainly used to generate detailed images conditioned on text descriptions, though it can also be applied to other tasks, including inpainting, outpainting, and generating image-to-image translations guided by a textual prompt. Stable Diffusion is a latent diffusion model, in the sense of a diffusion model that operates in a latent space instead of the pixel space. A latent diffusion model for image or video generation consists of three main parts: a latent encoder, a latent decoder, and a denoising autoencoder. The latent encoder encodes images to latent tensors, from pixel space to a smaller dimensional latent space, capturing a more fundamental semantic meaning of the images. Gaussian noise is applied to these latent encodings during forward diffusion, obtaining noise-contaminated versions of the original latent encodings. The denoising autoencoder estimates original latent encodings from the output from forward diffusion backwards. Finally, the latent decoder generates images by converting latent tensors back into image space. Stable Diffusion, as an example of latent diffusion model, uses a variational autoencoder (VAE) (comprising a VAE encoder E and a VAE decoder D) as latent encoder and latent decoder, and uses a U-Net as denoising autoencoder. The denoising steps of diffusion models can be flexibly conditioned on a string of text, an image, or another modality. Stable Diffusion, in particular, uses textual prompts as conditioning parameters.

As explained above, style adaptation of Stable Diffusion or similar text-to-image diffusion-based image generation models is currently done either by prompt engineering or by fine-tuning using a large number of examples. In the following, reference is made to Stable Diffusion, but it is to be noted that the teachings of the present invention can equally be applied to other diffusion-based image or video generation models.

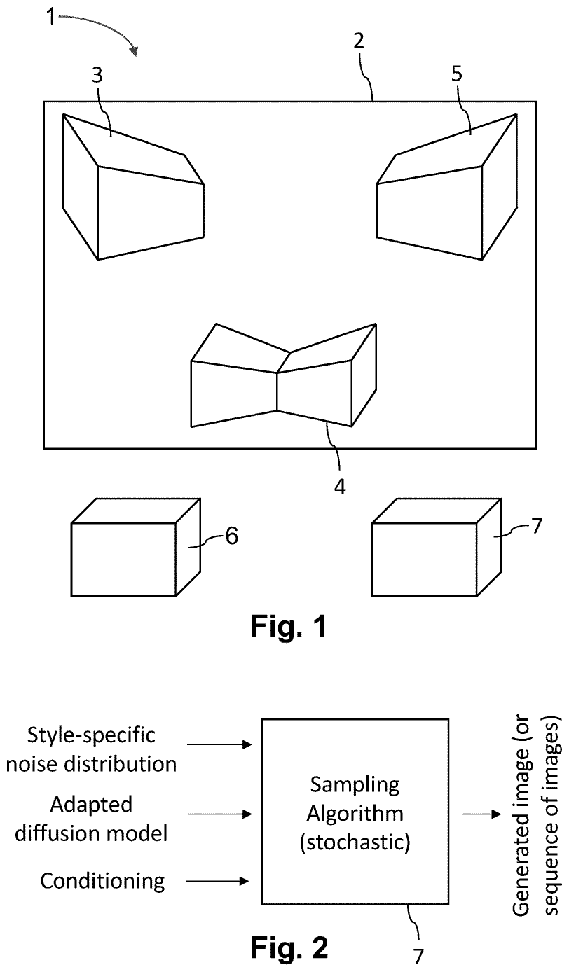

The simplified block diagram of FIG. 1 schematically illustrates some functional elements of an imaging system 1, where the teachings of the present invention can be implemented. Only elements that are relevant for understanding the teachings of the present invention are shown. The system comprises a pre-trained diffusion model 2, which in this example is a conditional diffusion-based image generation model, and more specifically text-to-image diffusion-based image generation model. However, images can also be generated unconditionally, and other types of conditioning parameters may also or instead be used, such as one or more voice inputs, gestures and/or images, etc. An image encoder 3 or latent encoder is provided to encode or process sets of images or sequences of images, i.e., videos. In this case the encoder 3 may be a VAE encoder configured to compress images from image space (in the case of Stable Diffusion, the images to be compressed are 512×512 pixels in three colours in the image space) to latent space (in the case of Stable Diffusion, the latent encodings of images are of 64×64×4 elements in the latent space, where the first two numbers, 64×64, define the size of the spatial dimensions of the latent space, and the remaining number, 4, may be understood as the number of channels of the latent space). The latent encoder 3 is thus configured to encode each image (or sequence of images) into a latent tensor. An artificial neural network 4 or a denoising autoencoder, which in this case is a convolution artificial neural network, such as a U-Net, is further provided to generate images based on prompt input. In other words, the denoising autoencoder 4 is configured to denoise noise-contaminated latent tensors (i.e., noisy latent tensors) or directly noisy images or videos. The pre-trained diffusion model 2 further comprises an image decoder 5 or latent decoder configured to decode images from latent space to image space. The latent decoder is thus configured to decode each latent tensor into an image (or a sequence of images).

Thus, the pre-trained diffusion model 2 for images (or sequences of images) is in this example composed of the latent encoder, the denoising autoencoder and the latent decoder. It is to be noted that some diffusion models work directly in the space of images (or sequences of images). In this case, the latent encoder and decoder can be considered as identity functions (not all diffusion models are latent diffusion models). In other words, they could in this case be omitted. An adaptation module 6 is also provided to generate or calculate adaptation parameters, such a mean and covariance values as well as parameter values used to fine-tune the denoising autoencoder 4 or another artificial neural network, as explained later in more detail. The adaptation module 6 is arranged to be in data communication with the denoising autoencoder 4. Depending on the implementation, the adaptation module 6 may be considered to be part of the diffusion model 2.

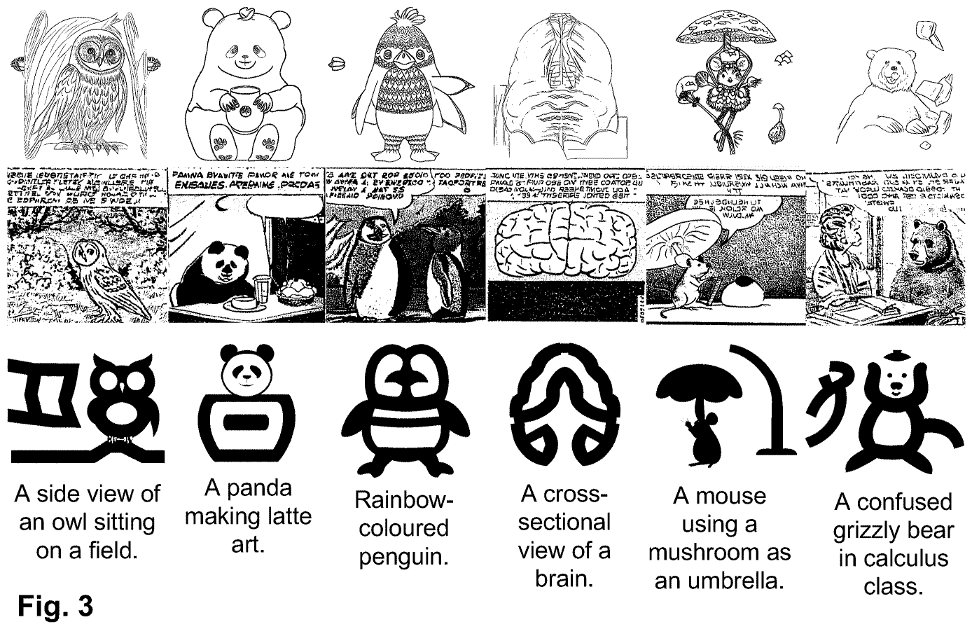

The system further comprises a sampling module 7 to generate images as further illustrated in FIG. 2. The sampling algorithm 7 may be a stand-alone module (in which case it is arranged in data communication with the denoising autoencoder) or it can be part of the denoising autoencoder. The denoising autoencoder 4 is used together with the sampling algorithm 7 to generate images as will be explained later in more detail. The image generation may be conditioned, e.g., on a class or label (which may be a category of an object), a textual prompt, an image, or conditioning parameters of another modality. The sampling algorithm is in this example stochastic. This means that it will generate different images each time it is used, even though all inputs are the same. This randomness is controlled by a noise distribution, from which the sampling algorithm can sample noise in the latent or image space. As shown in FIG. 2, the sampling algorithm 7 takes as inputs a style-specific noise distribution as explained later, an adapted diffusion model 4 and one or more conditioning parameters and then outputs a generated image or a sequence of images.

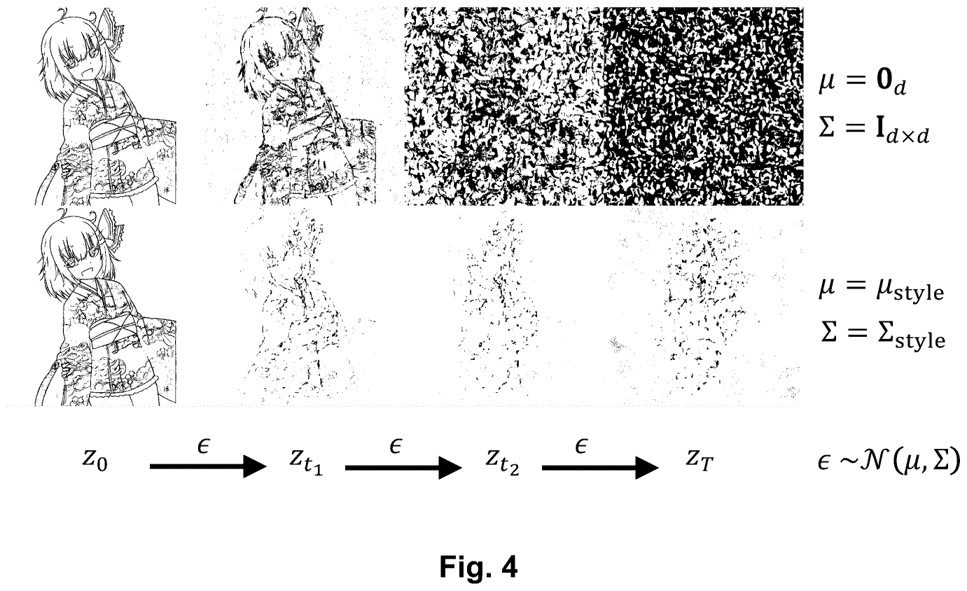

We present in the following an example embodiment of the present invention, which achieves superior results compared to existing solutions, and which is also computationally inexpensive. FIG. 3 shows examples of style adaptations induced by Diffusion in Style. A small number, e.g., 50, of target style images is used to efficiently adapt Stable Diffusion to a given style: sketch (first row), comics (middle row) and pictograms (bottom row). The adapted model can generate images in the desired style with any textual prompt similarly to Stable Diffusion. Each column is generated from only the textual prompt indicated at the bottom. The objects in the generated images do not need to be present in the target style images (not shown), which may be random images according to the target style.

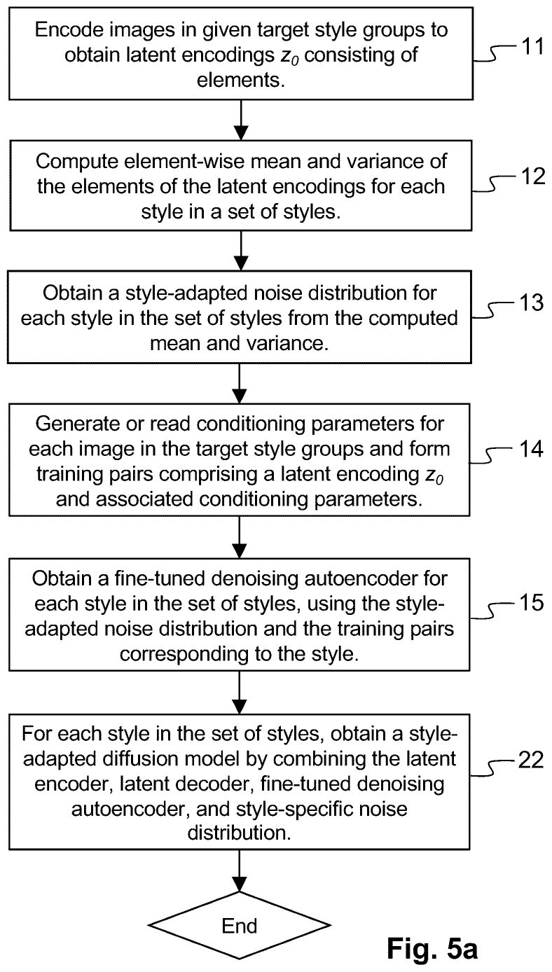

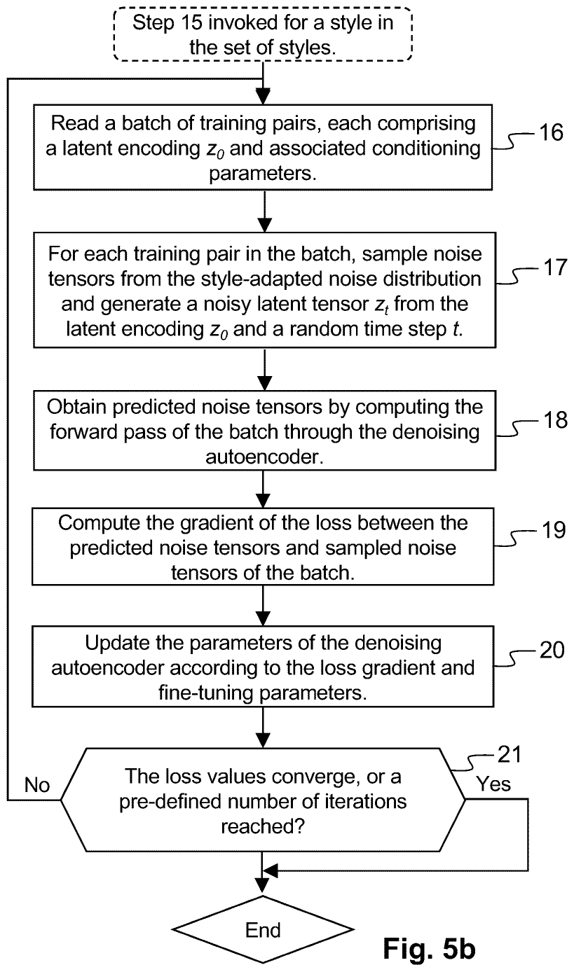

The forward diffusion process in Stable Diffusion degrades the training data using noise sampled from zero-mean identity-covariance multivariate Gaussian distribution, N(0_{d}, I_{d×d}), in the latent space of a VAE with d=4×64×64 dimensions (i.e., 16384 floating numbers per image). This forward diffusion process can be visualised in the image space, as illustrated in the first row of FIG. 4. The key idea of the proposed method is to use a style-adapted noise distribution. The main steps are explained below with reference to the flow chart of FIGS. 5a and 5b.

During a first phase, we obtain an adapted noise distribution, which is better suited for the target style. Our style-adapted noise distribution, N(μ_{style}, Σ_{style}), has a location μ_{style}∈R^{d} and a diagonal covariance matrix

$${\sum }_{style} = diag ( {σ}_{style}^{2} ) ∈ {R}^{d \times d} ,$$

with diagonal

$${σ}_{style}^{2} ∈ {R}^{d} .$$

In other words, each element Eₖ of the noise sample ∈∈R^{d} is sampled from

$$N ( {μ}_{style , k} , {σ}_{style , k}^{2} ) ,$$

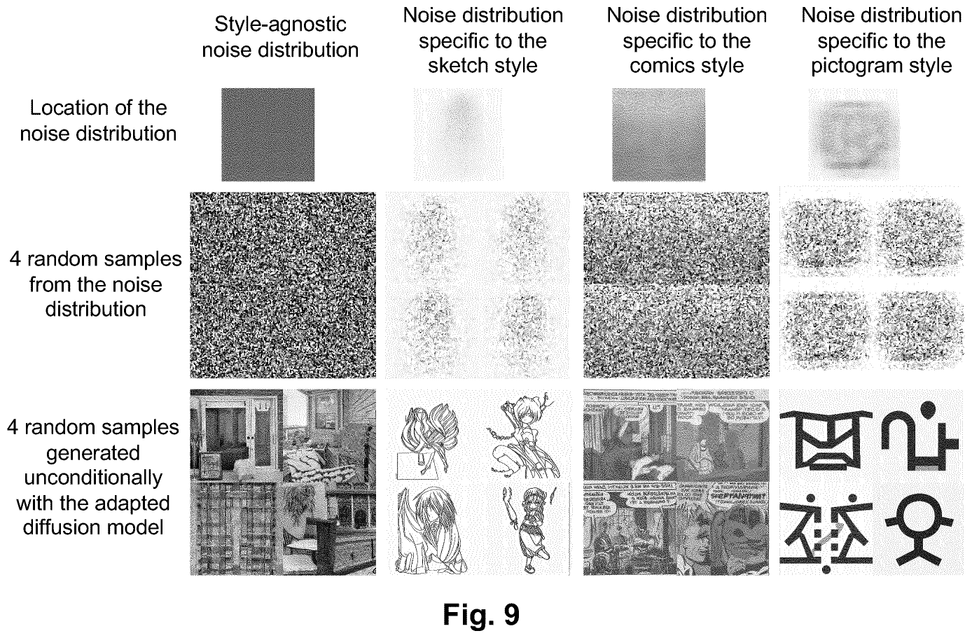

independently of other elements of the noise sample. Various noise samples are visualised in FIG. 9. Note that, in the original Stable Diffusion, the location μ∈R^{d} equals the vector 0_{d} and the covariance matrix Σ∈R^{d×d} equals the identity matrix I^{d×d}.

We compute values for the style-adapted location μ_{style} and the diagonal

$${σ}_{style}^{2}$$

of the covariance matrix from a set of target style images I_{style}. To do this, in step 11, we encode all the images i∈I_{style} of the target style with the latent encoder 3 E, to obtain the latent tensors E(i)∈R^{d}. In step 12, we compute the mean and variance of each element of those latent tensors, to obtain the mean latent tensor μ_{style} and the covariance matrix diagonal

$${σ}_{style}^{2} : ∀ k ∈ [ 1 ¨ d ] , {μ}_{style , k} = {Mean}_{i ∈ {I}_{style}} {E}_{k} ( i ) ∀ k ∈ [ 1 ¨ d ] , {σ}_{style , k} = {Std}_{i ∈ {I}_{style}} {E}_{k} ( i ) \qquad ( 1 )$$

Thus, the mean and variance are calculated element-wise for all the images in a given style or at least for some of the images in a given style. According to a variant, we could compute such means and variances for clusters of pixels across images or within a given image. In other words, the number of elements to compute the respective mean and variance values for the respective group of elements equals the number of target style images or the number of target style images multiplied by a coefficient. In this example, the encodings are tensors with d=4×64×64 dimensions, hence we compute d mean and variance values, i.e., μ_{style}∈R_{d} and

$${σ}_{style}^{2} ∈ {R}^{d} .$$

In step 13, a noise distribution N(μ_{style}, Σ_{style}) (one noise distribution per style), which in this example is a multivariate Gaussian distribution (i.e., normal distribution), is generated from the computed mean and variance values. Different noise ∈∈R^{d} can be sampled from a multivariate Gaussian distribution N(μ_{style}, Σ_{style}) with the computed mean and variance, assuming diagonal covariance

$${\sum }_{style} = diag ( {σ}_{style}^{2} ) ∈ {R}^{d \times d} .$$

More specifically, to compute the mean μ_{style,k} and variance σ_{style,k} of each element Eₖ(i) of the encodings, we use the naive estimators, i.e., empirical mean and biased sample variance:

$${μ}_{style , k} = \frac{{\sum }_{i ∈ {I}_{style}} {E}_{k} ( i )}{\vert {I}_{style} \vert} ∀ k ∈ [ 1 ¨ d ] {σ}_{style}^{2} = \frac{{\sum }_{i ∈ {I}_{style}} {( {E}_{k} ( i ) - {μ}_{style , k} )}^{2}}{\vert {I}_{style} \vert} ∀ k ∈ [ 1 ¨ d ] \qquad ( 2 )$$

Here, I_{style} is the set of target style images, |I_{style}| is the number of target style images, and Eₖ(i) is the k-th element of the encoding E(i) of image i.

In practice, instead of the biased sample variance, it would be possible to use other estimators. In our preliminary experiments, we found no significant difference using Bessel's correction for the estimation of the variance, i.e., dividing by (|I_{style}|−1) instead of |i_{style}|.

As simple as it is, sampling the initial latent tensors from the noise distribution N(μ_{style}, Σ_{style}) helps style-adapting Stable Diffusion very efficiently. As we illustrate in FIGS. 4 and 9, it can be understood intuitively that our adapted noise distribution better represents the target style, while the original noise distribution N(0_{d}, I_{d×d}) better represents the entire set of original training images of Stable Diffusion. Thus, it makes sense to sample the initial latent tensor z_{T} from the noise distribution adapted to the style rather than from the style-agnostic one. FIG. 4 illustrates conventional versus style-adapted forward diffusion, visualised in the image space via the latent decoder 5 D. The top row of FIG. 4 illustrates conventional forward diffusion process for Stable Diffusion, and the bottom row illustrates our forward diffusion process adapted to the sketch style with Diffusion in Style. z₀∈R^{d} is the VAE encoding of an original image from the target style. z₀ is degraded with noise ∈˜N(μ, Σ) to obtain more and more noisy latent tensors zₜ, which become almost indistinguishable from ∈ after T noising steps. Targeting the sketch style, it is much easier for a model to learn the reverse diffusion, i.e., from right to left, of the bottom row.

Next, we fine-tune the denoising autoencoder 4 (which has previously been trained) on the target style images, using the adapted noise distribution. We use the adapted forward diffusion process as illustrated in the second row of FIG. 4 to fine-tune the denoising autoencoder. We sample noise from the adapted noise distribution N(μ_{style}, Σ_{style}) instead of N(0_{d}, I_{d×d}). This makes the fine-tuning require orders of magnitude fewer target style images and iterations.

To fine-tune the denoising autoencoder 4, we need pairs containing an image and an associated set of conditioning parameters, which can for instance comprise the caption of the image.

In step 14, we generate conditioning parameters for the target style images and form the conditioning pairs, used as training samples for fine-tuning. More specifically, each image-conditioning pair contains an image from the target style image set, and, in this example, the caption of the image is obtained automatically using for instance bootstrapping language-image pre-training (BLIP), which is a state-of-the-art vision-and-language model that can, among other tasks, generate captions from images. Other image captioning models may instead be used, or captions may be assigned to images manually, i.e., without machine assistance. Other sets of conditioning parameters may be used instead of image captions, for instance, labels, images, voices, or combinations of conditioning parameters from different modalities. The sets of conditioning parameters can also be empty, for instance to adapt unconditional image-generation diffusion models.

In step 15, we fine-tune the denoising auto-encoder using the training image-conditioning pairs obtained in step 14. The fine-tuning strategy is similar to the training of Stable Diffusion. The fine-tuning step 15 is an iterative process, comprising steps 16 to 21 carried out for each style. In step 16, images i with their associated set of conditioning parameters are read one batch at a time from the set of training samples, and the encodings z₀=E(i) of the images of the batch are computed using the latent encoder 3 E. In step 17, we sample noise from the style-specific noise distribution and generate noisy latent tensors zₜ with a random time step by using the sampled noise. More precisely, for each training sample of the batch, noise E is sampled from N(μ_{style}, Σ_{style}) to generate noisy latent tensors zₜ=\sqrt{āₜ}z₀+1−\sqrt{āₜ}∈, with a random time step t. āₜ denotes a term that controls the noise schedule, and it is thus a function linking the time step t to a specific noise variance. The denoising autoencoder 4 is given noisy latent tensors zₜ, their associated random time steps t, and their associated sets of conditioning parameters. It outputs a predicted noise tensor \hat{∈}=\hat{∈}ₚᵣₒₘₚₜ. In other words, in step 18, we feed a plurality of tensor-conditioning pairs (where the tensors zₜ are noise-contaminated versions of the latent encodings z₀) with respective time steps to the denoising autoencoder 4 and obtain predicted noise as an output of the denoising autoencoder. In step 19, the gradient of the loss with respect to the parameters of the denoising autoencoder 4 is computed. The loss function is designed to measure the error between the predicted noise tensors and true noise tensors. In step 20, we update the parameters of the denoising autoencoder 4 by using the loss gradient. This update is performed according to fine-tuning parameters, including for instance the optimiser update rule (e.g., gradient descent algorithm or Adam optimiser) and the learning rate value. In other words (steps 18, 19, 20), a mean squared error (MSE) loss or another loss value between the predicted noise e and the true noise e is used to perform one optimisation iteration of the parameters of the denoising autoencoder. The count of iterations is used to determine whether the fine-tuning process is over (step 21: yes). If not, the iteration count is incremented by 1 and a new training iteration begins at step 16.

While fine-tuning the denoising autoencoder 4, we optionally randomly drop the captions X % of the time to improve image generation with classifier-free guidance. Variable X which is understood as the random caption dropping value may take a value between 0% and 20% or more specifically 5 and 20, or 7 to 13. At the end of the training, we save an exponential moving average of the parameters of the denoising autoencoder 4. The number of fine-tuning iterations per image style may be between 200 and 2000 or more specifically between 200 and 1500 or 200 and 1200, and the number scales with the batch size. The number of images defining the desired style ranges from 3 to 500 or more specifically between 3 and 250, the learning rate ranges from 10⁻⁷ to 10⁻³, and the rate scales with the batch size, the image resolution ranges from 256×256 to 768×1536, the number of images in the sequence of images ranges from 1 to 32, the gradient clipping is at least 0.1 and the batch size ranges from 1 to 1024, while the decay factor for exponential moving average ranges from 1% to 100%, and the factor scales with the batch size and learning rate.

In step 22, after fine-tuning, a style-adapted diffusion model is obtained by combining the fine-tuned denoising autoencoder with the style-specific noise distribution, the latent encoder, and the latent decoder.

Next, to generate an image with Diffusion in Style, we sample in step 23, as explained before, the initial latent tensor z_{T} from the adapted noise distribution N(μ_{style}, Σ_{style}) and we use the fine-tuned denoising autoencoder 4 in step 24 to progressively denoise this latent tensor. At inference time, one can optionally select, among a few other parameters, set of conditioning parameters (e.g., a textual prompt), and a guidance weight. The denoised latent tensor is processed in step 25 by the latent decoder to obtain the generated image or sequence of images.

The guidance weight may be used for classifier-free guidance to efficiently generate images from text. In a few words, the guidance weight w≥1 is used to combine the noise predictions \hat{∈}ₚᵣₒₘₚₜ and Ê_{uncond} of the denoising autoencoder 4 conditioned with and without the textual prompt into an improved noise prediction \hat{∈}. A guidance weight w≥1 amplifies the direction \hat{∈}ₚᵣₒₘₚₜ predicted when conditioning on the prompt, using \hat{∈}_{uncond} as a reference. Intuitively, this makes the denoising step \hat{∈} move in a direction that is better aligned with the textual prompt. This fidelity to the prompt is obtained at the expense of the style match.

In the case of Diffusion in Style, the guidance weight is particularly useful: it controls how close the generated images are to the target style or to the textual prompt. For low guidance weights, the generated images are closer to the target style but do not match the textual prompt well. For high guidance weights, the images resemble the textual prompt, but the style might suffer. As with the original Stable Diffusion, we also observe that the image quality is degraded for very high guidance weights. Note that, depending on the style, the optimal guidance weight may differ. One option is to manually select one guidance weight for each style. In practice, it can be worth generating several versions of each image with different guidance weights to be able to visually choose the best one.

As mentioned, the guidance weight is particularly useful in the case of Diffusion in Style, as it controls how close the generated images are to the target style or to the textual prompt. This guidance weight is used for classifier-free guidance. In practice, the guidance weight w≥1 is used to combine the noise predictions \hat{∈}_{uncond} and \hat{∈}ₚᵣₒₘₚₜ of the denoising autoencoder 4 conditioned with and without the textual prompt with the following equation:

$$\hat{ϵ} = {\hat{ϵ}}_{uncond} + w ( {\hat{ϵ}}_{prompt} - {\hat{ϵ}}_{uncond} ) \qquad ( 3 )$$

A guidance weight w=1 corresponds to taking denoising steps without classifier-free guidance, i.e., \hat{∈}=\hat{∈}ₚᵣₒₘₚₜ. A guidance weight w>1 amplifies the direction (\hat{∈}ₚᵣₒₘₚₜ−\hat{∈}_{uncond}), aligning the generated images more with the textual prompt.

A variation of classifier-free guidance, where the unconditional prediction \hat{∈}_{uncond} is replaced with a “negative” prediction €negative, is also possible when using Diffusion in Style. More specifically, in Equation 3, the predicted noise ∈̅_{uncond} when the denoising autoencoder 4 is not conditioned on the textual prompt can be replaced with \hat{∈}_{negative}, which is the predicted noise when conditioning the denoising autoencoder 4 on a so-called negative prompt. With negative textual prompting, the classifier-free guidance becomes:

$$\hat{ϵ} = {\hat{ϵ}}_{negative} + w ( {\hat{ϵ}}_{prompt} - {\hat{ϵ}}_{negative} ) \qquad ( 4 )$$

Note that Equations 3 and 4 are equal when classifier-free guidance is not used, i.e., when the guidance weight w=1. For w>1, the direction (\hat{∈}ₚᵣₒₘₚₜ−\hat{∈}_{negative}) is amplified, meaning the generated image should be more aligned with the textual prompt and less aligned with the negative textual prompt.

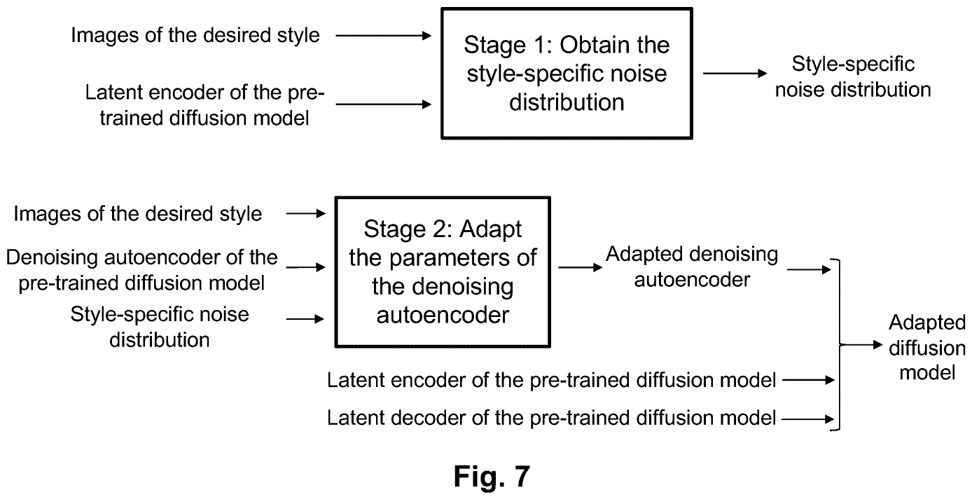

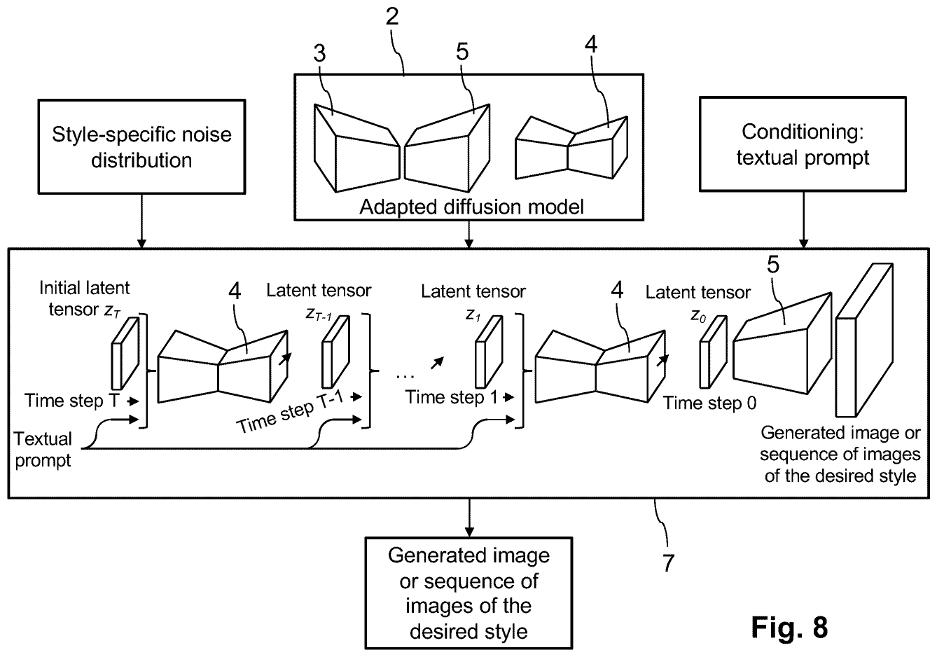

The above-described process is summarised in FIGS. 7 and 8. FIG. 7 illustrates in a simplified manner the two main phases or stages of the proposed method. In stage 1, the style-specific noise distribution is obtained as explained above. Stage 1 corresponds to steps 11 to 13 of the flow chart of FIG. 5a. This stage takes two inputs, namely images of the desired style (i.e., target style images) and the latent encoder 3 of the pre-trained model 2. However, the latent encoder is optional if the diffusion process is done directly in the image space instead of being done in the latent space as in this example. The output of stage 1 is the style-specific noise distribution. In stage 2, the parameters of the denoising autoencoder 4 are adapted or modified. Stage 2 corresponds to steps 14 and 15 of the flow chart of FIG. 5a and thus it also corresponds to steps 16 to 21 of the flow chart of FIG. 5b. This stage takes three inputs, namely images of the desired style (encoded with the latent encoder 3), the denoising autoencoder 4 of the pre-trained diffusion model 2 and the style-specific noise distribution obtained in stage 1. The adapted denoising autoencoder 4 forms the output of this stage. An adapted diffusion model 2 is then formed by the adapted denoising autoencoder 4, the latent encoder 3 of the pre-trained diffusion model and the latent decoder 5 of the pre-trained diffusion model. Here again, the latent encoder and the latent decoder are optional if the diffusion process is done directly in the image space.

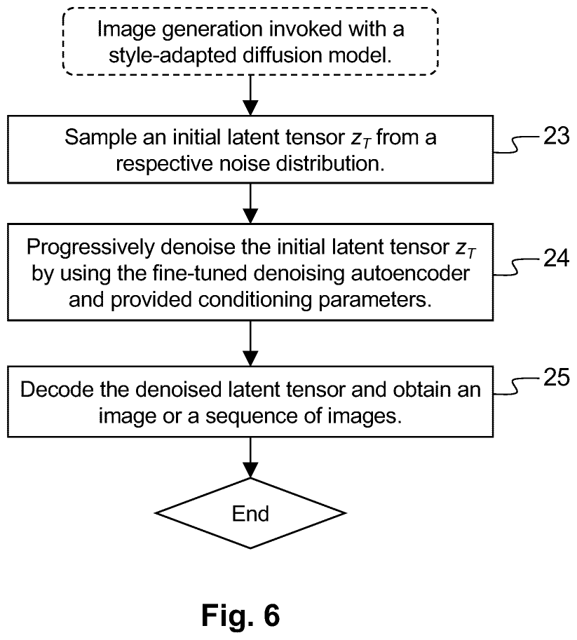

FIG. 8 illustrates schematically how the adapted diffusion model 2 may be used in practice. In this example, the adapted diffusion model 2 is used to generate new images of a desired style based on conditioning, which in this example is a textual prompt. FIG. 8 thus illustrates steps 23 to 25 of the flow chart of FIG. 6. As shown in FIG. 8, the sampling algorithm takes three inputs, namely a style-specific noise distribution N(ustyle>>style), the adapted diffusion model 2 and the textual prompt. The initial latent tensor z_{T} as schematically shown on the left-hand side of the sampling algorithm 7 is sampled from the style-specific noise distribution N(μ_{style}, Σ_{style}). The sampling algorithm 7 then gradually denoises the initial latent tensor by applying at each denoising step the textual prompt (which may or may not be the same at each denoising step) and finally outputs an image or a sequence of images of the desired style. At each denoising step, the respective latent tensor is processed by the denoising autoencoder 4.

In FIG. 9, for a style-agnostic noise distribution, as well as for each example style, we visualise in the image space the location of the noise distribution, four random samples from the respective noise distribution (four random initial latent tensors zr), and four unconditional image generations obtained with Diffusion in Style (we progressively denoise these initial latent tensors z_{T} with the fine-tuned denoising autoencoder 4, to generate images according the desired style. The visualisations in the image space are thus obtained using the latent decoder 5 D. Intuitively, it can be understood from FIG. 9 that the adapted noise distribution N(ustyle>>style) better represents the style, while the style-agnostic distribution N(0_{d}, I_{d×d}) better represents the original training images of Stable Diffusion.

For most image styles, Diffusion in Style works well with 50 to 200 target style images. To make Diffusion in Style work with even fewer images, e.g., n=3, we optionally apply the following modifications to our method. We further impose the location μ_{style} (tensor of R^{64×64×4} in the case of Stable Diffusion) and the covariance diagonal

$${σ}_{style}^{2}$$

(tensor of R^{64×64×4} in the case of Stable Diffusion) to be constant across (all) the spatial dimensions (in this example the two dimensions of 64×64) of the latent space. We therefore compute their values in this example, not only from n samples, which may provide an unreliable estimate of the style-adapted latent distribution, but from 64×64×n samples, as follows:

$$∀ k ∈ [ 1 ¨ 4 ] , ∀ {k}_{2} , {k}_{3} ∈ [ 1 ¨ 64 ] \times [ 1 ¨ 64 ] , \qquad ( 5 )$$

$${μ}_{style , ( {k}_{1} , {k}_{2} , {k}_{3} )} = {Mean}_{i ∈ {I}_{style} {j}_{2} ∈ [ 1 ¨ 64 ] {j}_{3} ∈ [ 1 ¨ 64 ]} {E}_{( {k}_{1} , {j}_{2} , {j}_{3} )} ( i ) ,$$

$${σ}_{style , ( {k}_{1} , {k}_{2} , {k}_{3} )} = {Std}_{i ∈ {I}_{style} {j}_{2} ∈ [ 1 ¨ 64 ] {j}_{3} ∈ [ 1 ¨ 64 ]} {E}_{( {k}_{1} , {j}_{2} , {j}_{3} )} ( i )$$

In other words, we assume the noise distribution to be spatially constant and compute its location and covariance diagonal channel-wise instead of element-wise. Thus, the mean and variance values for any given element are computed from samples the number of which equals the size of the spatial dimensions multiplied by the number of target style images. Alternatively, instead of computing the mean and variance values element-wise or channel-wise, the values could be computed cluster-wise, i.e. for clusters of pixels (or latent elements), across images or within a given image. In other words, the mean and variance values for any given element could be computed from samples the number of which equals a coefficient multiplied by the number of target style images. We may also use the naive estimators of mean and variance for Equation 5 as explained in connection with Equation 2. Furthermore, to avoid fine-tuning the denoising autoencoder with only n captions, which could lead to catastrophic forgetting, we may generate, for instance with BLIP, not only one but a plurality of captions per image, for instance 2 to 100, or more specifically between 5 and 50 captions per image. At the time of fine-tuning, the captions are used alternatively as conditioning parameters for the denoising autoencoder. Finally, instead of fine-tuning for instance for 1000 iterations, we stop at 250 iterations, which amounts to less than 5 minutes of fine-tuning.

The steps of the method as described above are computer-implemented steps. The invention thus also relates to a non-transitory computer program product comprising instructions for implementing the steps or at least some of the steps of the method when loaded and run on computing means of a computing device.

While the invention has been illustrated and described in detail in the drawings and foregoing description, such illustration and description are to be considered illustrative or exemplary and not restrictive, the invention being not limited to the disclosed embodiments. Other embodiments and variants are understood, and can be achieved by those skilled in the art when carrying out the claimed invention, based on a study of the drawings, the disclosure and the appended claims. Further variants may be obtained by combining the teachings of any of the designs explained above.

In the claims, the word “comprising” does not exclude other elements or steps, and the indefinite article “a” or “an” does not exclude a plurality. The mere fact that different features are recited in mutually different dependent claims does not indicate that a combination of these features cannot be advantageously used. Any reference signs in the claims should not be construed as limiting the scope of the invention.

1. A method of adapting a diffusion-based image generation model comprising at least a denoising autoencoder, the method comprising:
obtaining a style-specific noise distribution in an image space or in a latent space for a respective set of target style images; and
adjusting parameters of the denoising autoencoder by using the style-specific noise distribution to adjust the parameters of the denoising autoencoder to obtain an adapted diffusion-based image generation model.

2. The method according to claim 1, wherein the style-specific noise distribution is obtained by computing element-wise, cluster-wise or channel-wise mean and variance for a respective group of elements of the target style images in the image space or in the latent space.

3. The method according to claim 2, wherein the number of elements to compute respective mean and variance values for the respective group of elements equals the number of target style images or the number of target style images multiplied by a coefficient, or wherein the number of elements to compute respective mean and variance values for the respective group of elements equals the size of at least of one of the spatial dimensions of the target style images multiplied by the number of target style images.

4. The method according to claim 1, wherein the diffusion-based image generation model further comprises a latent encoder, wherein the method further comprises the latent encoder encoding the respective set of target style images from the image space to a set of target style images in the latent space, and wherein the style-specific noise distribution is obtained for the set of target style images in the latent space.

5. The method according to claim 1, wherein the method further comprises generating conditioning parameters for the set of target style images and forming image-conditioning pairs, a respective image-conditioning pair comprising a respective target style image with a respective associated conditioning parameter, and wherein the method further comprises feeding the image-conditioning pairs with associated time steps to the denoising autoencoder to adjust the parameters of the denoising autoencoder.

6. The method according to claim 5, wherein the conditioning parameters comprise textual prompts.

7. The method according to claim 5, wherein the conditioning parameters are generated automatically for the target style images.

8. The method according to claim 1, wherein the method further comprises generating a set of noisy target style images in the image space or in the latent space by degrading the set of target style images in the image space or in the latent space with noise sampled from the style-specific noise distribution and using the noisy target style images to adjust the parameters of the denoising autoencoder.

9. The method according to claim 8, wherein the sampling is carried out with a stochastic sampling algorithm.

10. The method according to claim 8, wherein the method further comprises feeding some of the noisy target style images with associated time steps but without conditioning parameters to the denoising autoencoder to adjust the parameters of the denoising autoencoder.

11. The method according to claim 8, wherein the number of conditioning parameters per noisy target style image is zero, or wherein the number of conditioning parameters per noisy target style image is one, or wherein the number of conditioning parameters per noisy target style image is at least two.

12. The method according to claim 5, wherein the method further comprises obtaining gradient values of the loss between predicted noise and true noise as a result of feeding the image-conditioning pairs with the associated time steps to the denoising autoencoder to adjust the parameters of the denoising autoencoder by using the gradient values.

13. The method according to claim 1, wherein the number of target style images in the set of target style images is comprised between 3 and 500, and more specifically between 3 and 250.

14. The method according to claim 1, wherein the style-specific noise distribution has constant location and variance across one or more spatial dimensions.

15. A method of generating an image of a desired style by using a diffusion-based image generation model adapted according to claim 1, wherein the method comprises:
sampling an initial noise sample from the style-specific noise distribution in the image space or in the latent space; and
denoising the initial noise sample by using the adapted diffusion-based image generation model to generate the image of the desired style.

16. The method according to claim 15, wherein the denoising further comprises applying one or more conditioning parameters to the adapted diffusion-based image generation model.

17. The method according to claim 16, wherein the conditioning parameter is kept unchanged during the denoising operation.

18. The method according to claim 16, wherein the method further comprises applying a guidance weight to the denoising autoencoder to indicate how well the image to be generated should correspond to the one or more conditioning parameters at the expense of the desired style.

19. A non-transitory computer program product comprising instructions for implementing the steps of the method according to claim 1 when loaded and run on computing means of a computing device.

20. A diffusion-based image generation system comprising at least a denoising autoencoder, the system being configured to perform operations comprising:
obtain a style-specific noise distribution for a respective set of target style images in an image space or in a latent space; and
adjust parameters of the denoising autoencoder by using the style-specific noise distribution to adjust the parameters of the denoising autoencoder to obtain an adapted diffusion-based image generation model.
